(19) United States
(12) Patent Application Publication
(10) Pub. No.: US 2004/0262122 A1
(43) Pub. Date: Dec. 30, 2004

(54) Coin drop mechanism

(76) Inventor: James G. Horian, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/602,796

(22) Filed: Jun. 24, 2003

(51) Int. Cl. G07F 5/00; G07F 11/00; G07F 15/00; G07F 13/00; G07F 17/00

(52) U.S. Cl. 194/247

(57) ABSTRACT

A coin drop mechanism comprises a support member movably connected to a channel member. A contoured channel configured to receive at least one coin is formed on at least one of the members and defines a coin slot when the members are in contact with each other. The channel is configured to guide the at least one coin to a desired location aligned with an actuator opening on the members. The mechanism further comprises an actuator. The actuator comprises a actuation member configured to travel through the actuator opening, engage the at least one coin against a surface of the channel member, and displace the channel member relative to the support member causing a selected product to be dispensed from a product receptacle.

### BACKGROUND OF THE INVENTION

1. Field of the Invention

The present invention relates to vending machines and, more particularly, to a coin mechanism used to actuate vending machines.

2. Description of the Related Art

Vending machines and coin mechanisms for operating such machines are well known in the art. Such vending machines are located in a variety of locations, often making the machines subject to weather extremes and abuse, such as fraudulent attempts to obtain product without inserting the required purchase price. Accordingly the coin mechanism for such machines must be of a non-complex design capable of withstanding such abuse.

Some conventional coin mechanisms are complex and utilize electronic parts to actuate the coin mechanism. Other conventional coin mechanism designs are mechanically operated but employ a complex arrangement. Although such mechanisms may be versatile and perform well under ideal conditions, they are inherently expensive and prone to requiring frequent maintenance due to the harsh conditions under which vending machines sometimes operate.

Conventional coin mechanism designs that are mechanically operated usually require a user to turn a knob or rotate a lever to actuate the mechanism. Such modes of actuation are difficult and sometimes painful for individuals with limited hand movement, such as individuals who suffer from arthritis or similar debilitating conditions.

### SUMMARY OF THE INVENTION

In one embodiment of the present invention, a coin mechanism includes a coin slot formed via the interaction of two movably joined members, where at least one of the members has a contoured channel formed thereon. The contoured channel is configured to receive and guide at least one coin of a required denomination to a desired position aligned with an actuator opening on at least one of the members.

A user can actuate the coin mechanism to dispense a product by actuating an actuator. The actuator causes an actuation member to travel through the actuator opening in one member, engage a coin against the surface of the channel member, and displace the channel member relative to the support member. The channel member is connected to a product delivery system, which is configured to deliver a desired product upon displacement of the channel member.

The coin mechanism advantageously does not require complex electronic or mechanical parts. Additionally, the mechanism advantageously does not require the turning of a knob or rotation of a lever, minimizing the discomfort or pain suffered by individuals with limited hand movement during actuation of the mechanism.

Further, the contoured shape of the of the coin mechanism channel advantageously prevents fraudulent attempts to obtain a selected product by inserting, for example, an elongated flat object into the coin slot instead of the at least one coin.

Other embodiments, advantages, and features of the present invention will become readily apparent to those skilled in this art from the ensuing detailed description of preferred embodiments thereof.

### BRIEF DESCRIPTION OF THE DRAWINGS

FIG. 1a is a frontal perspective view of one embodiment of a coin mechanism.

FIG. 1b is a rear perspective view of the mechanism of FIG. 1.

FIG. 1c is an exploded perspective view of the coin drop mechanism of FIG. 1.

FIG. 1d is a perspective frontal view of a coin receiving channel member in accordance with one embodiment of a coin drop mechanism.

FIG. 1e is perspective view of the coin receiving channel member in FIG. 1 d with a coin of a different denomination than required by the coin drop mechanism.

FIG. 1f is a rear perspective view of a support member in accordance with one embodiment of a coin drop mechanism.

FIG. 2a is a crossectional side view of a vending machine incorporating one embodiment of a coin drop mechanism in a non-actuated state.

FIG. 2b is a crossectional side view of the vending machine of FIG. 2a with the coin drop mechanism in an actuated state.

FIG. 2c is a crossectional view of the vending machine of FIG. 2a with the coin drop mechanism in an actuated state while dispensing the last product in the machine.

FIG. 3a is a crossectional side view of another vending machine incorporating one embodiment of a coin drop mechanism in a non-actuated state.

FIG. 3b is a crossectional side view of the vending machine of FIG. 3ain an actuated state.

FIG. 3c is a crossectional side view of the vending machine of FIG. 3ain an actuated state while dispensing the last product in the machine.

### DETAILED DESCRIPTION OF THE PREFERRED EMBODIMENT

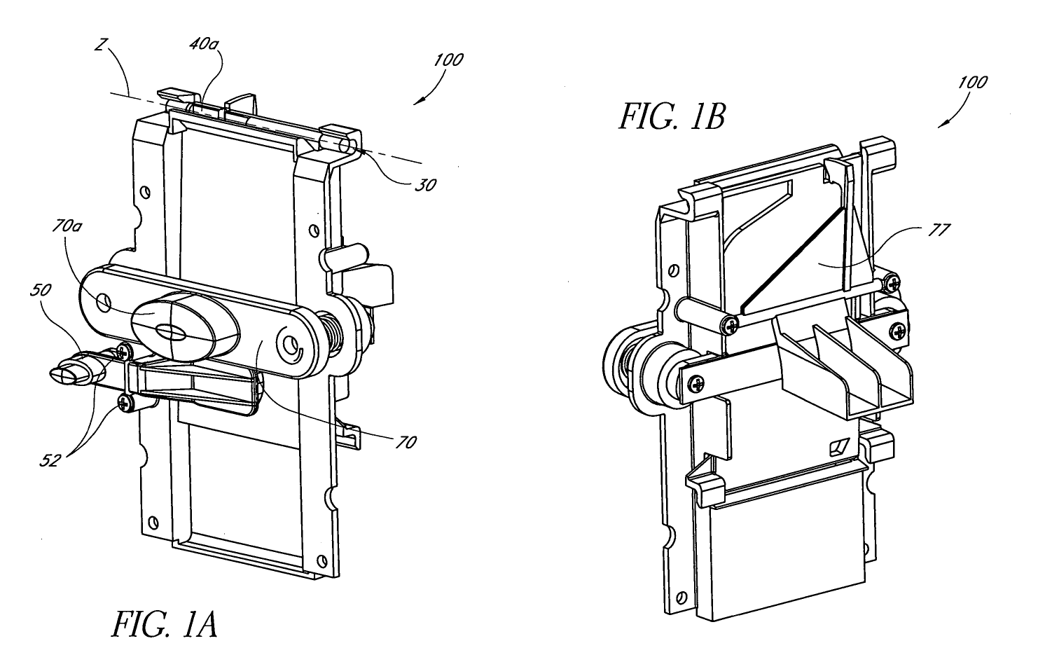

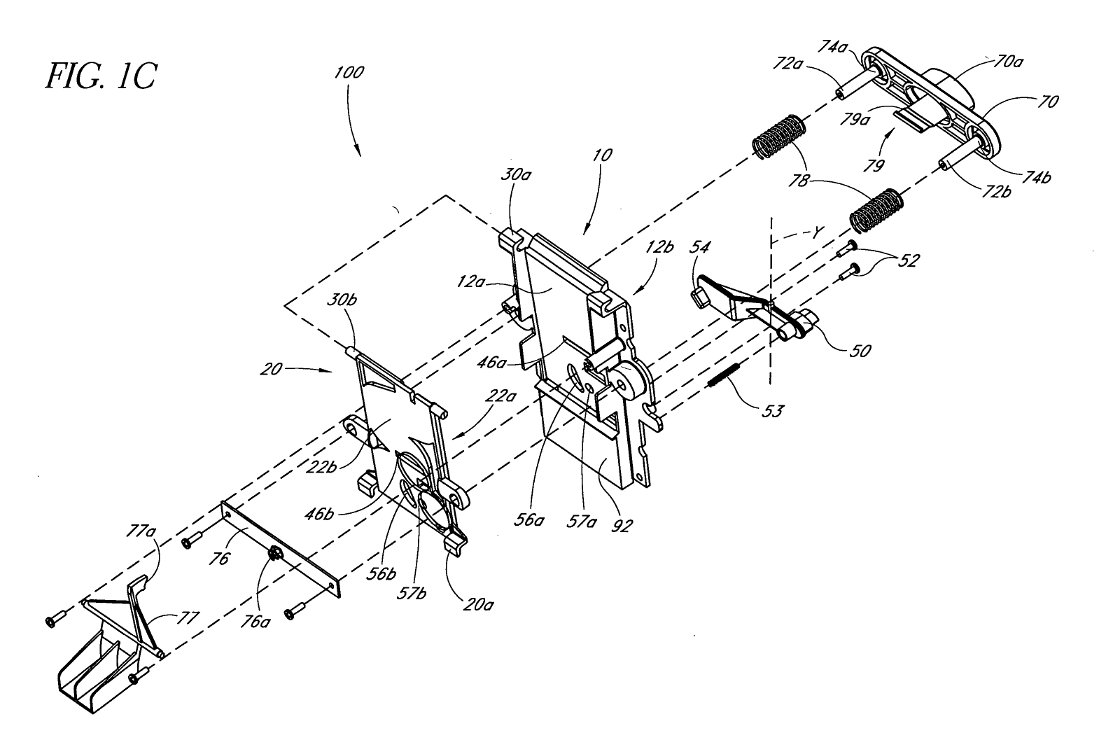

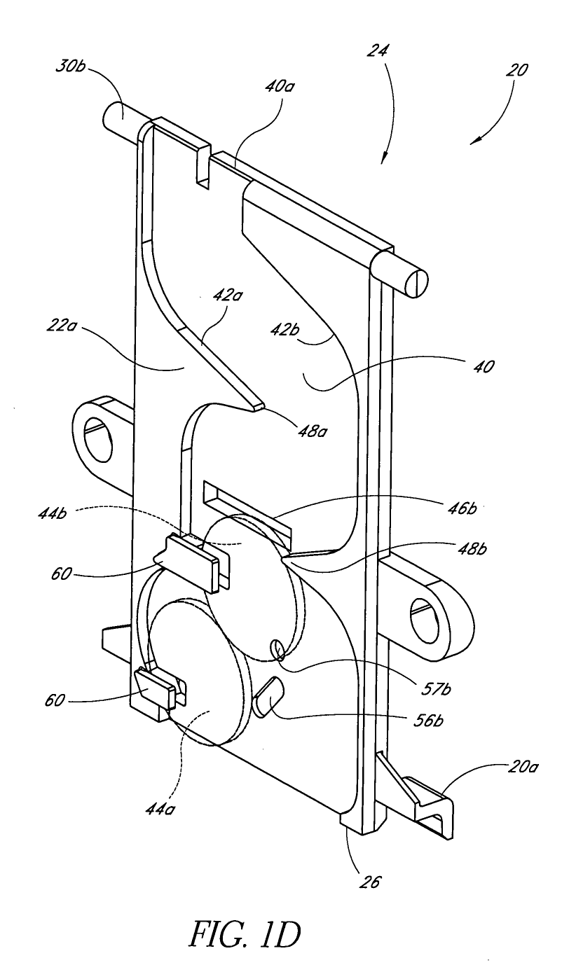

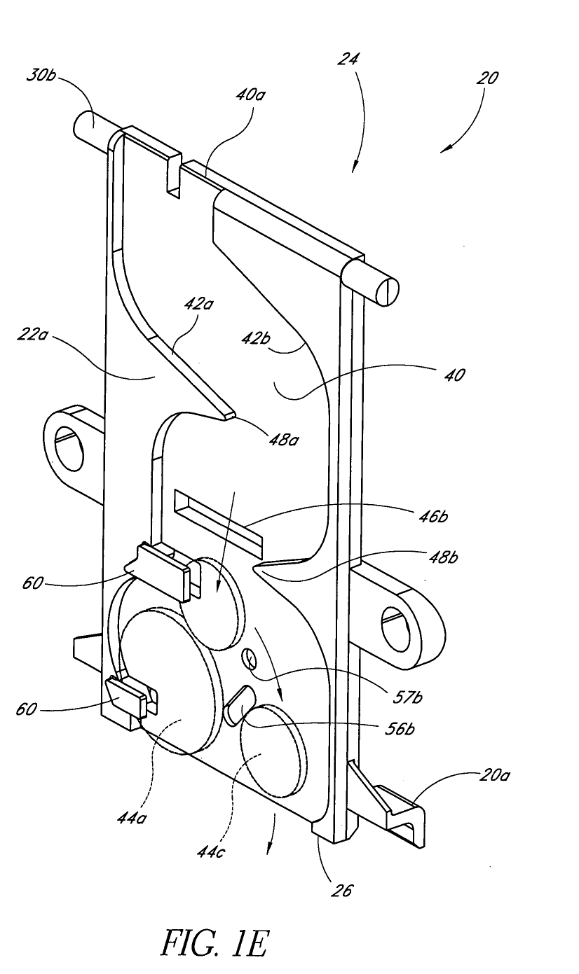

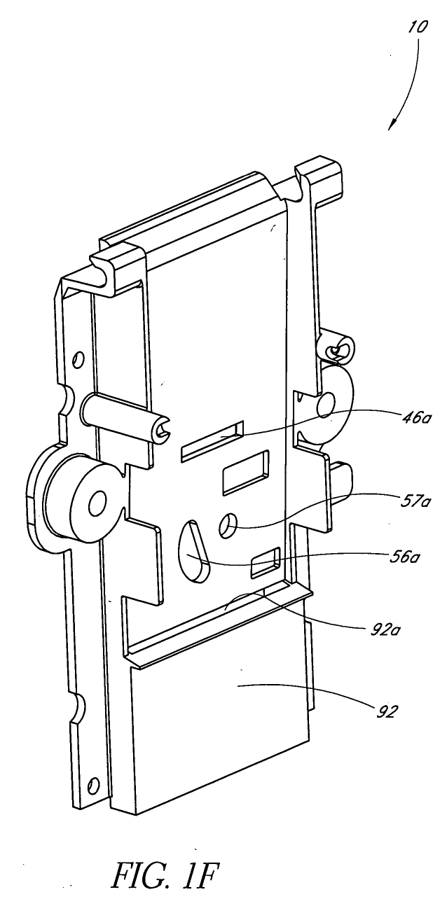

FIG. 1a-1f illustrate a coin mechanism 100 according to one embodiment of the present invention. The mechanism 100 preferably comprises a support member 10 and a channel member 20. The members 10, 20 are shown as plates 10, 20 in the illustrated embodiment. However, the members 10, 20 are not limited to any geometrical shape. The members 10, 20 comprise inner surfaces 12a, 22a and outer surfaces 12b, 22b, respectively.

The members 10, 20 are preferably made of metal, such as steel or aluminum. However, the members 10, 20 can be made of any material having structural characteristics suitable for use in a coin mechanism 100, such as a hard plastic. Additionally, the members 10, 20 are preferably connected together so as to allow movement of the members 10, 20 relative to each other about an axis “Z”. For example, the support member 10 can have a female portion 30a, such as a hook, and the channel member 20 can have a male portion 30b configured to fit in the female portion 30a to form a hinge 30 that connects the members 10, 20. However, the members 10, 20 can be connected using any structure that allows them to pivot relative to each other.

At least one of the members 10, 20 preferably comprises a contoured channel 40 formed on a surface thereof extending from a proximal end 24 to a distal end 26. In the illustrated embodiment, the channel 40 is formed on the inner surface 22a of the channel member 20. The channel 40 is configured to define a slot 40a between the members 10, 20 when the members 10, 20 are in contact with each other.

The channel 40 comprises a first and second contoured walls 42a, 42b. The walls 42a, 42b preferably extend from the proximal end 24 to the distal end 26 of the channel 40. Additionally, the walls 42a, 42b are preferably configured to allow coins of denominations other than that required for operation of the mechanism 100 to fall through the channel 40, as discussed further below.

The contoured channel 40 is preferably configured to receive and guide at least one coin of a specific denomination required by the mechanism 100 to a desired location on the channel 40. Accordingly, the channel member 20 functions as a coin receiving channel member. For example, the channel 40 can be configured to receive quarters. Additionally, the contoured walls 42a, 42b are preferably configured to allow the mechanism 100 to operate only with coins of the specific denomination, as discussed further below.

Two coins 44a, 44b are shown in the illustrated embodiment, but it is understood by one of ordinary skill in the art that the mechanism 100 can equally operate with any number of coins. In one embodiment, the contoured channel 40 guides X-1 of X-number of coins (not shown) inserted into the mechanism 100 to a desired location, such that the X-1 coins are disposed substantially adjacent to each other about a common axis. In this embodiment, the channel 40 is configured to guide the X coin to a location on top of the X-1 coins. As used herein, X represents a numerical quantity of coins.

As illustrated in FIGS. 1c-d, the channel 40 is further configured to align one of the coins 44b with actuator openings 46a, 46b formed on the members 10, 20 when the coin 44b is in the desired location. The contoured walls 42a, 42b of the channel 40 each preferably comprises at least one protrusion 48a, 48b configured to help guide the coins 44a, 44b to the desired location.

The mechanism 100 optionally comprises a coin return actuator 50 removably connected to the support member 10 with a fastener 52. The actuator 50 can optionally comprise a spring 53 and be configured to pivot about an axis “Y” defined by the fastener 52. The fastener 52 can be, for example, a bolt or a screw or multiple bolts or screws, or a snap-fit pivot. However, one of ordinary skill in the art will recognize that any fastener 52 suitable for removably connecting the coin return actuator 50 to the support member 10 can be used.

The coin return actuator 50 preferably comprises a protrusion 54 configured to protrude through an opening 56a formed on the support member 10, through the channel 40, and into a recessed opening 56b formed on the channel 40. The protrusion 54 is further preferably configured to contact and hold one coin 44a against the contoured wall 42a when the coin return actuator 50 is not actuated. Similarly, when the coin return actuator 50 is actuated, the protrusion 54 is preferably configured to disengage the coin 44a, to travel out of the recessed opening 56b, and to travel into the opening 56a at least enough so the protrusion 54 does not protrude from the inner surface 12a of the support member 10.

In the illustrated embodiment, the coin mechanism 100 is configured to operate with two coins 44a, 44b, such as quarters. As noted above, the protrusion 54 is configured to engage one of the coins 44a against the contoured wall 42a when the coin return actuator 50 is not actuated. The protrusion 54 is preferably disposed in relation to the contoured walls 42a, 42b so as to contact and hold only coins inserted into the channel 40 that are of the specific denomination required for operation of the mechanism 100. That is, coins of a different denomination than that required for the actuation of the mechanism 100 would fall through the channel 40 into a coin return area 92, preferably formed on the support member 10 and aligned with the channel 40, via a coin return slot 92a. Additionally, the protrusion 54 is further preferably disposed in relation to the contoured walls 42a, 42b such that even if a user inserted a first coin 44a of the required denomination into the channel 40, said coin 44a held by the protrusion 54, coins of a different denomination 44c subsequently inserted into the channel 40 would fall through the channel 40 into the coin return area 92, as illustrated in FIG. 1e.

In another embodiment, the coin mechanism 100 is configured to operate with just one coin 44b. In this embodiment, the protrusion 54 is preferably configured to extend through a second opening 57a formed on the support member 10, through the channel 40, and into a second recessed opening 57b formed on the channel 40. For example, the protrusion 54 can have a cylindrical shape (not shown) configured to contact and hold the coin 44b against the contoured wall 42a. As discussed above, the protrusion 54 is preferably disposed in relation to the contoured walls 42a, 42b so as not to contact and hold coins inserted into the channel 40 that are not of the specific denomination required for operation of the coin mechanism 100. For example, if the coin mechanism 100 is configured to operate with one quarter, and a user instead inserts a nickel, the nickel would fall through the channel 40 and into a coin return area 92.

The mechanism 100 optionally comprises at least one coin guide 60 disposed, for example, on the inner surface 22a of the channel member 20. The at least one coin guide 60 preferably protrudes over the contoured channel 40 and is configured to contact the at least one coin 44a, 44b during actuation of the coin mechanism 100.

FIG. 1c illustrates an exploded view of one embodiment of the coin drop mechanism 100. The coin drop mechanism 100 preferably comprises an actuator 70 disposed frontward of the outer surface 12b of the support member 10.

The actuator 70 preferably comprises a contact portion 70a and at least one support element slidably disposed through the members 10, 20. The actuator 70 comprises two support elements 72a, 72b in the illustrated embodiment. Each of the support elements 72a, 72b defines a front portion 74a, 74b disposed between the contact portion 70a and the support member 10. The support elements 72a, 72b preferably removably connect to a third member 76 disposed next to the channel member 20. The third member 76 preferably comprises a spring 76a configured to contact a flag member 77a movably connected to the support member 10. Each front portion 74a, 74b preferably comprises a spring element 78. The actuator 70 further comprises an actuation member 79 configured to travel through at least one of the actuator openings 46a, 46b of the members 10, 20. In one embodiment, the actuation member 79 preferably is a rectangular metal bar or plate formed, for example, via a stamping process. However, the actuation member 79 can have other shapes suitable for use in the coin mechanism 100, such as square, oval, and round. Additionally, the actuation member 79 can be made of other materials with structural characteristics suitable for use in the coin mechanism 100, such as a hard plastic.

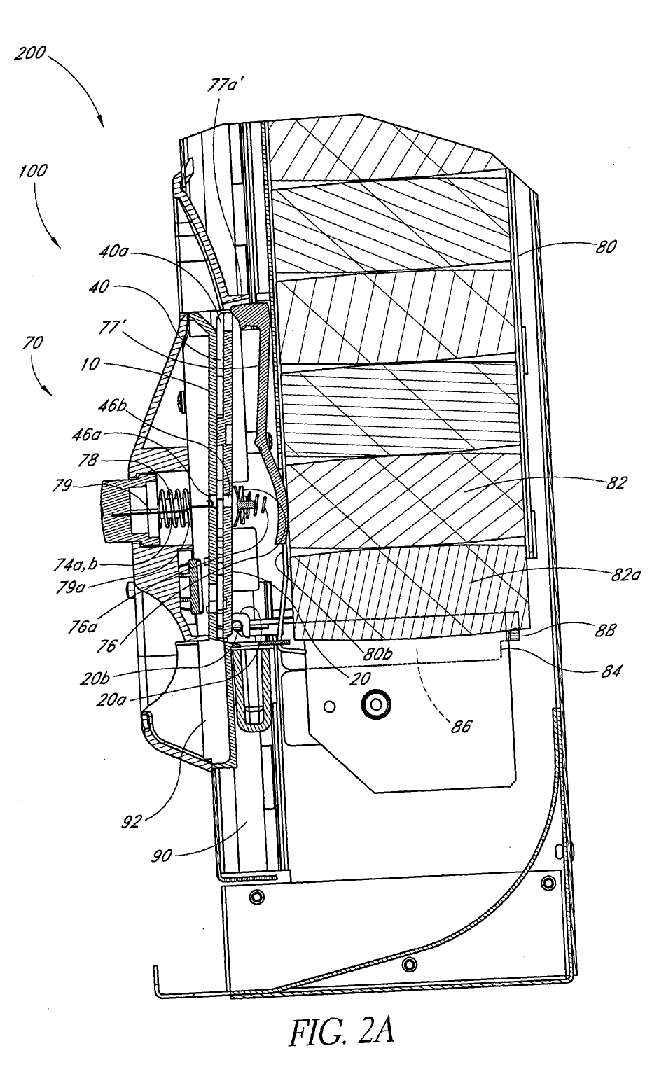

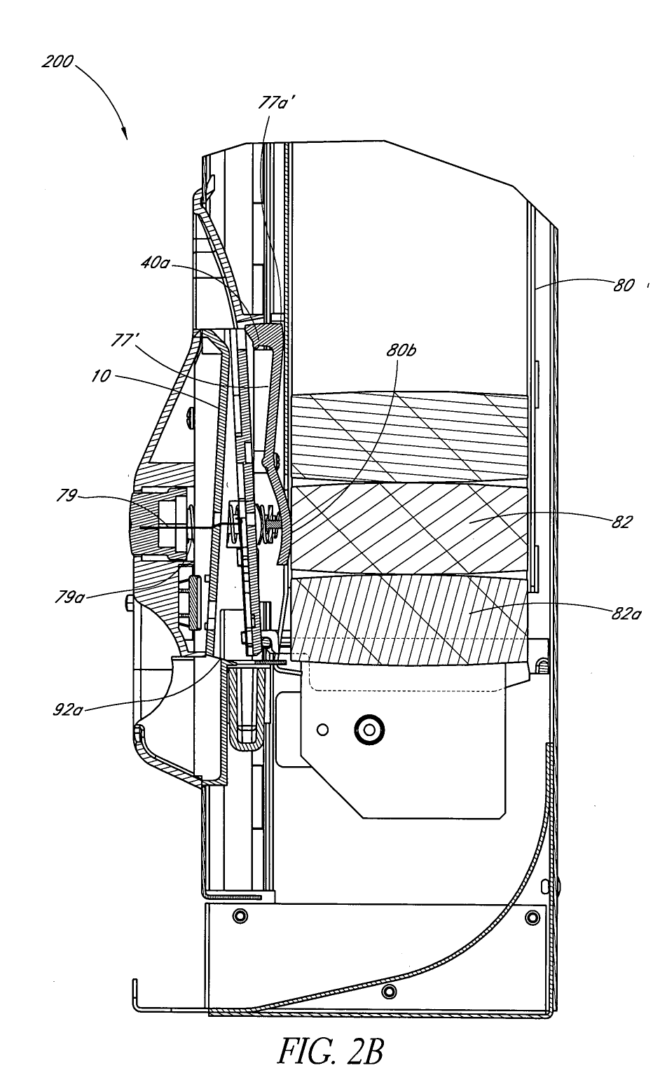

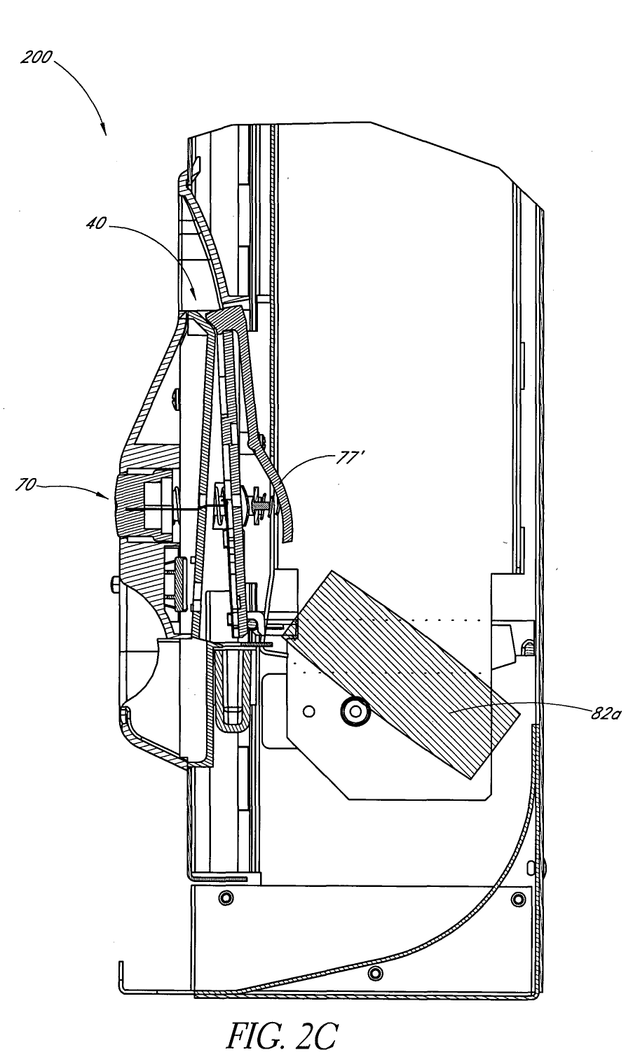

FIG. 2a illustrates a vending machine 200 incorporating one embodiment of the coin drop mechanism 100. The vending machine 200 preferably has a product receptacle 80 configured to hold at least one product 82 therein. In the illustrated embodiment, the product receptacle 80 is configured to receive and hold a plurality of individual products 82. The channel member 20 preferably connects to a product support member 84 defining an opening 86 therethrough. For example, in one embodiment, the channel member 20 has a female portion 20a, such as a hook, that removably receives a male portion 20b of the product support member 84 therein. However, any structure suitable for connecting the channel member 20 to the product support member 84 can be used. In one embodiment, the channel member 20 and the product support member 84 are integrally formed. The opening 86 of the support member 84 defines an edge 88 configured to contact and support a selected product 82a in the product receptacle 80. Additionally, in one embodiment, the product support member 84 can be slidably connected to the product receptacle 80 via a rail system (not shown). Alternatively, the product support member 84 can be movably connected to the product receptacle 80 using other suitable structure(s).

During operation, a user inserts the at least one coin 44a, 44b into the slot 40a. The channel 40 guides the at least one coin 44a, 44b to a desired location, preferably via gravity, such that the at least one coin 44b is aligned with the actuator openings 46a, 46b. The user then preferably actuates the actuator 70 by pressing the contact portion 70a, thus generating an actuation force.

When a user actuates the actuator 70, the support elements 72a, 72bmovably displace through the members 10, 20, which in turn displaces the third member 76 such that the spring 76a contacts the flag member 77′, as shown in FIG. 2b. The spring 76apreferably causes the flag member 77′ to pivot so as to contact and hold in place at least one of the products 82 in the product receptacle 80 through an opening 80b. The products 82 are preferably disposed above the selected product 82a. At least one spring element 78 disposed on the front portions 74a, 74b of the support elements 72a, 72b generates a return force on the contact portion 70a of the actuator 70.

Additionally, actuation of the actuator 70 causes the actuation member 79 to travel through the actuator opening 46a in the support member 10, engage the at least one coin 44b with an edge thereof, and transmit the actuation force to the at least one coin 44b to displace the channel member 20 relative to the support member 10, as shown in FIG. 2b. Displacement of the channel member 20 relative to the support member 10 causes at least one of the coins 44a, 44b to fall into a coin bank 90. Also, displacement of the channel member 20 in turn displaces the product support member 84 such that the opening 86 is aligned with the selected product 82a, causing the selected product 82a to be dispensed from the receptacle 80, as shown in FIG. 2c. In one embodiment, the actuation member 79 comprises a stepped portion 79a along its length. At some point during the actuation process, when the stepped portion 79a passes through the actuator opening 46a in the support member 10, the edge in contact with the at least one coin 44b shifts relative to the coin 44b, causing the edge to release the coin 44b, which falls into the coin bank 90. Release of the coin 44b preferably coincides with the dispensing of the selected product 82a from the receptacle 80.

Upon release of the actuator 70, the support elements 72a, 72b movably displace such that the spring 76a of the third member 76 disengages the flag member 77′, which in turn disengages the product(s) 82 in the receptacle 80. Additionally, the actuation member 79 withdraws from the channel member 20 and into the actuator opening 46a. The return force caused by the at least one spring element 78 causes the third member 76 to displace the channel member 20 into contact with the support member 10. Displacement of the channel member 20 in turn displaces the product support member 84 such that the edge 88 of the opening 86 contacts and supports the products 82 in the product receptacle 80.

The coin mechanism 100 advantageously prevents dispensation of a product without having inserted the required number of coins into the mechanism 100. If a user attempts to obtain a product without any coins in the mechanism 100 by actuating the actuator 70, the actuation member 79 travels through the actuator openings 46a, 46b in both members 10, 20 without causing the channel member 20 to displace relative to the support member 10. Additionally, the contoured walls 42a, 42b of the channel 40 prevent a user from inserting, for example, an elongated flat element into the coin slot 40a in an attempt to actuate the coin mechanism 100 without inserting the at least one coin 44a, 44b. Further, as discussed above, the coin mechanism 100 advantageously prevents use of coins that are not of the specific denomination required by the mechanism 100, by allowing said different coins to fall through the channel 40 and into the coin return area 92 via the coin return slot 92a.

Additionally, the at least one coin guide 60 also advantageously prevents the at least one coin 44a, 44b from falling into the coin return area 92 when the mechanism 100 is actuated. The at least one coin guide 60 is configured to direct the at least one coin 44a, 44b away from a location above the coin return area 92 and toward a location above the coin bank 90 when the mechanism 100 is actuated to displace the channel member 20 relative to the support member 10.

In one embodiment, the flag member 77′ advantageously prevents a user from inserting coins into the coin slot 40a when the vending machine 200 is out of product. As discussed above, during actuation of the coin mechanism 100, the flag member 77′ contacts and holds at least one of the products 82 in the product receptacle 80 while the product support member 84 is displaced so as to dispense only the selected product 82a, as shown in FIGS. 2b-c. When there is only one selected product 82a in the receptacle 80, and there is not at least one product 82 disposed above the selected product 82a, actuation of the coin mechanism 100 causes the spring 76a of the third member 76 to pivot the flag member 77′ into a locked position such that a blocking portion 77a′ protrudes into the slot 40a. The blocking portion 77a′ prevents a user from inserting coins into the coin slot 40a after the last selected product 82a has been dispensed. The flag member 77′ can be reset to an unlocked position by an operator upon placement of at least one product 82, in addition to the selected product 82a, in the receptacle 80.

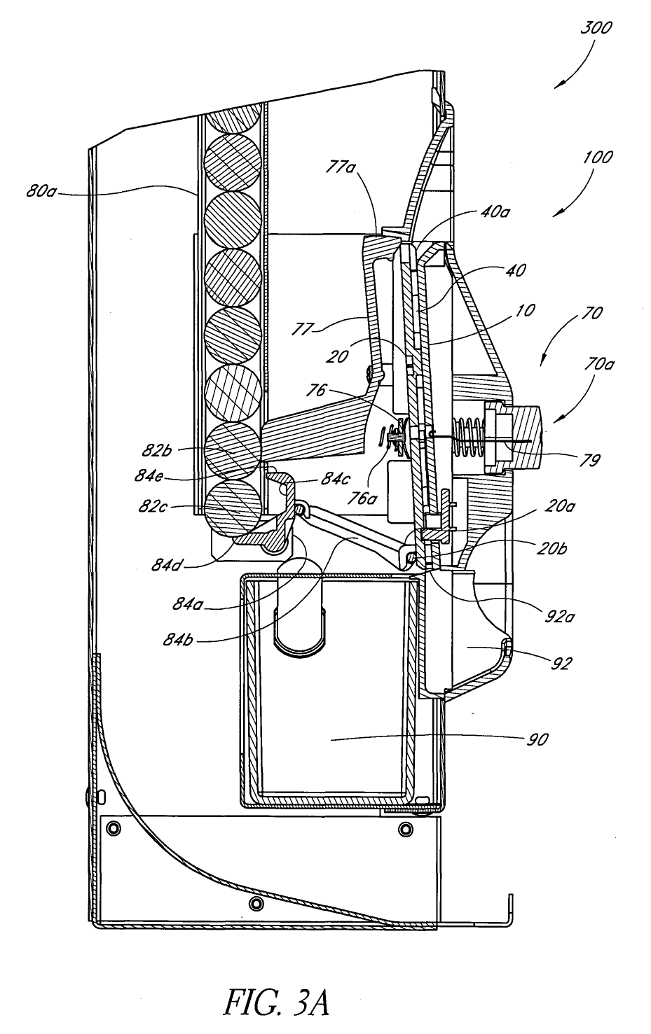

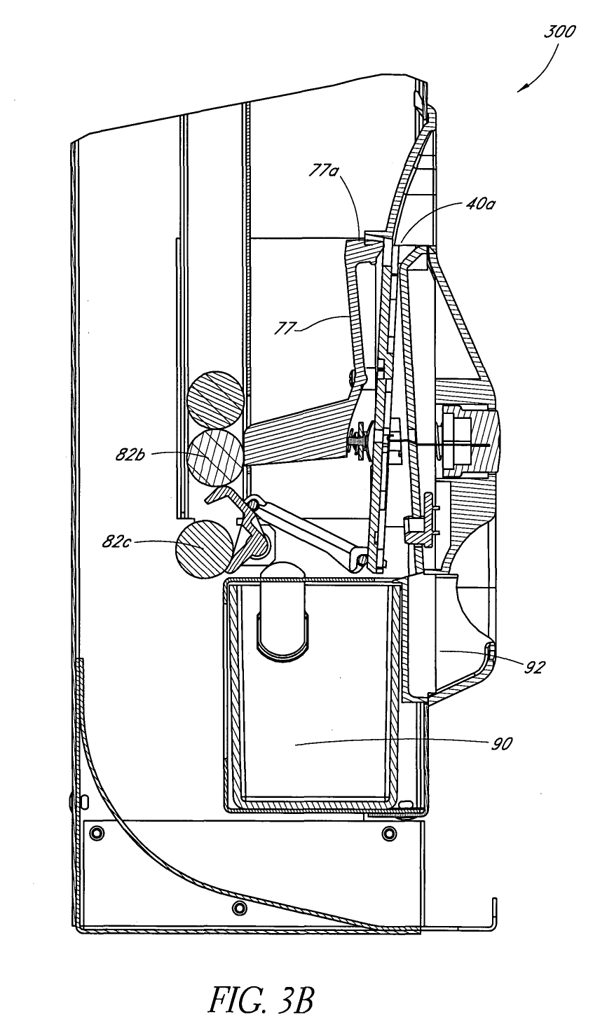

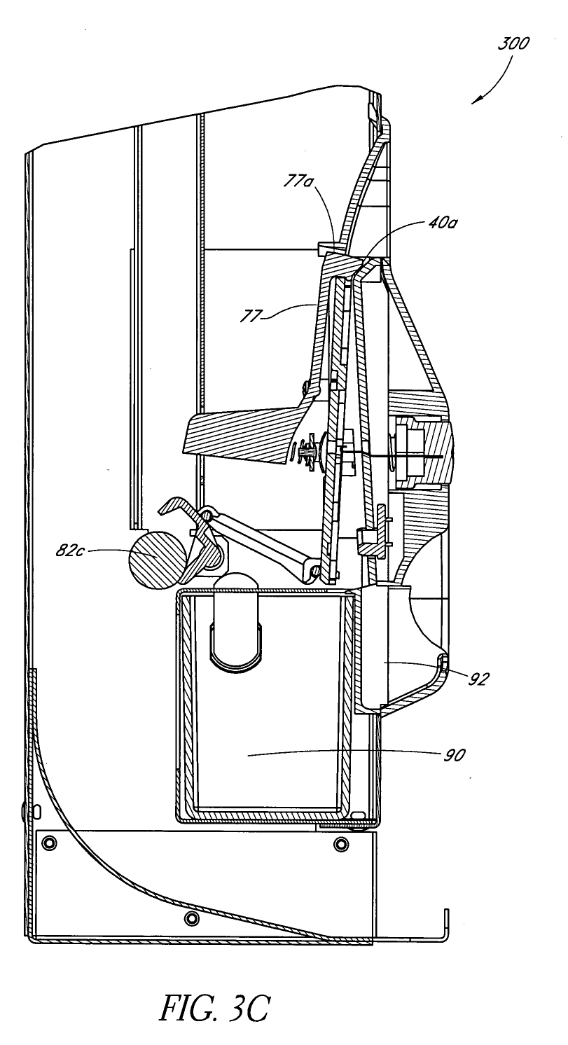

FIGS. 3a-c illustrate another vending machine 300 incorporating one embodiment of the coin drop mechanism 100. The vending machine 300 preferably comprises an alternate design for a product support member 84a used in conjunction with the coin mechanism 100. The product support member 84a preferably pivotally connects to the product receptacle 80a and a connector 84b. The connector 84b in turn connects to the channel member 20. In the illustrated embodiment, the product receptacle 80a is configured to preferably receive a plurality of products 82b having a circular crossection. The product support member 84a preferably comprises a generally concave surface 84c configured to contact a selected product 82c, when the coin mechanism 100 is not actuated. The generally concave surface 84c preferably defines a lower edge 84d and an upper edge 84e.

As previously described, upon actuation of the coin mechanism 100, the channel member 20 is displaced relative to the support member 10. As shown in FIG. 3b, the channel member 20 in turn displaces the connector 84b toward the receptacle 80a, causing the product support member 84a to rotate such that the lower edge 84d does not support and is not disposed beneath the selected product 82c, and the upper edge 84e is above the selected product 82c and supports the at least one product 82b. Accordingly, the selected product 82d can be dispensed as discussed above.

Upon release of the actuator 70, the channel member 20 returns into contact with the support member 10, as previously described. In turn, the channel member 20 displaces the connector 84b away from the receptacle 80a, causing the product support member 84a to rotate such that the lower edge 84d supports and is disposed beneath one of the products 82b, which becomes the selected product 82c.

The flag member 77 is generally in an unlocked position when there is at least one product 82b in the product receptacle 80a above the selected product 82c. However, the flag member 77 is preferably biased to move into a locked position when there is not at least one product 82b in the product receptacle 80a disposed above the selected product 82c, as shown in FIG. 3c. In the locked position, the blocking portion 77aprotrudes into the slot 40a, preventing a user from inserting coins into the mechanism 100. Optionally, the spring 76a can move the flag member 77 into the locked position upon actuation of the mechanism 100 when there is not at least one product 82b in the product receptacle.

Although the inventions disclosed herein have been disclosed in the context of certain preferred embodiments and examples, it will be understood by those skilled in the art that the inventions disclosed herein extend beyond the specifically disclosed embodiments to other alternative embodiments and/or uses of the inventions and obvious modifications and equivalents thereof. Thus, it is intended that the scope of the inventions disclosed herein should not be limited by the particular disclosed embodiments described above, but should be determined only by a fair reading of the claims that follow.

What is claimed is:

1. A coin drop mechanism for activating a vending machine which does not require the user to turn a knob or rotate a lever to activate the vending machine, said coin drop mechanism comprising,
a coin receiving channel member configured to receive two or more coins, said channel configured to temporarily retain said coins, said channel member having an actuator opening, said opening being blocked by the final coin required to be inserted to complete the purchase;
an actuator depressed by the user after insertion of the required number of coins, said depressed actuator engaging the coin blocking said actuator opening and causing said channel member to pivotally displace about an axis, said pivotable movement occurring only when said coin blocks said opening, said actuator otherwise passing through said opening in said channel member without pivotably displacing the channel member; and
a product support member supporting a plurality of the product offered for sale, said product support member actuated by the pivotable displacement of said channel member to dispense the purchased product.

2. A coin drop mechanism for activating a vending machine to dispense a product offered for sale comprising:
a channel member configured to receive at least one coin and direct said coin to a dispense enabling location in the channel having an actuator opening, said opening being blocked when said coin resides in said location;
said channel member having a contoured non-linear passageway for inhibiting theft of said product offered for sale by preventing use of a foreign object to cover said actuator opening;
an actuator configured to engage a coin located at said dispense enabling location and hold said coin against said channel member to pivotally displace the channel member about an axis, said pivotal movement occurring only when a coin resides at said dispense enabling location, said actuator otherwise passing through said actuator opening in said channel member without pivotally displacing the channel member; and
a product support member supporting a plurality of the product offered for sale, the support member configured to be displaced by the pivotal displacement of the channel member to dispense the product offered for sale.

3. A coin mechanism for a vending machine requiring at least one coin before a selected product will be dispensed, comprising:
a support member;
a channel member movably connected to the support member;
a contoured channel formed on at least one of the support and channel members and configured to receive and guide the at least one coin to a desired location; and
an actuator opening formed on the support and channel members aligned with the at least one coin disposed in the desired location, the actuator opening configured to receive an actuation member therethrough onto the at least one coin, the actuation member configured to transmit an actuation force onto the at least one coin to displace the channel member relative to the support member to dispense the selected product.

4. A coin mechanism for a vending machine requiring at least one coin before a selected product will be dispensed, comprising:
a support member;
a channel member movably connected to the support member;
a contoured channel formed on at least one of the support and channel members and configured to receive and guide the at least one coin to a desired location;
an actuator opening formed on the support and channel members aligned with the at least one coin disposed in the desired location; and
an actuator configured to transmit a force through the actuator opening onto the at least one coin disposed in the desired location to displace the channel member relative to the support member to dispense the selected product.

5. The coin mechanism of claim 4 further comprising:
a flag member removably connected to the support member, wherein the flag member is configured to be pivotably displaced into a locked position blocking at least a portion of a coin slot defined between the support member and the channel member when there is no product disposed above the selected product.

6. A coin mechanism for a vending machine requiring at least one coin before a selected product will be dispensed, comprising:
a support member having an inner surface and an outer surface;
a channel member movably connected to the support member, the channel member having a contoured channel formed thereon, the channel configured to define a coin slot when the channel member is in contact with the support member, the channel configured to receive and guide the at least one coin to a desired location, an actuator opening formed on the support and channel members at a location corresponding to the location of the at least one coin in the desired location, the channel member configured to normally be in contact with the support member and to displace relative to the support member when the coin mechanism is actuated;
a coin return actuator connected to the support member, the return actuator comprising at least one protrusion protruding through the support member, the member configured to hold the at least one coin at least in part against a wall of the contoured channel when the channel member is in contact with the support member, the at least one member further configured to travel in a second actuator opening formed on the support member to release the at least one coin into a coin return receptacle upon actuation of the coin return actuator;
an actuator comprising
a contact portion disposed frontward of the support member,
at least one support element movably disposed through the support and channel members, the at least one support element having a front portion disposed between the contact portion and the support member, and
an actuation member configured to protrude through the actuator opening in the support member and engage the at least one coin disposed in the desired location against the channel member upon actuation of the coin mechanism; and
a product support member connected to the channel member, the product support member comprising an edge configured to releasably support the selected product disposed in a product receptacle, the edge configured to not support the selected product upon actuation of the coin mechanism, causing the selected product to be dispensed, the product support member further configured to releasably engage at least one product in the product receptacle disposed above the selected product following the dispensation of the selected product.

7. The coin mechanism of claim 6, wherein the channel member is hinged to the support member.

8. The coin mechanism of claim 6, wherein the channel member is rotatably connected to the support member.

9. The coin mechanism of claim 6 further comprising at least one coin guide attached to the channel member and protruding over the contoured channel, wherein the at least one coin guide is configured to prevent the at least one coin disposed in the contoured channel from being released to the coin return receptacle when the channel member is displaced relative to the support member during actuation of the coin mechanism.

10. The coin mechanism of claim 6, wherein the channel member is configured to release at least one coin into a coin bank when the channel member is displaced relative to the support member during actuation of the coin mechanism.

11. The coin mechanism of claim 6, wherein the actuation member is configured to protrude through the actuator opening formed on the channel member when the actuator is actuated by a user without the at least one coin disposed in the desired location, preventing the selected product from being dispensed.

12. The coin mechanism of claim 6, wherein a spring is disposed between the channel member and the product receptacle, the spring configured to displace a flag member to engage at least one product disposed above the selected product through an opening in the product receptacle during actuation of the coin mechanism.

13. The coin mechanism of claim 12, wherein a second spring is disposed at the front portion of the at least one support element, the second spring configured to generate a return force on the contact portion when the actuator is actuated by a user.

14. The coin mechanism of claim 6, wherein the product support member is removably attached to the channel member.

15. The coin mechanism of claim 6, wherein the product support member defines an opening, the support member displaced upon actuation of the coin mechanism so that the edge removes support from the selected product, causing the selected product to be dispensed through the opening.

16. The coin mechanism of claim 6, wherein the product support member has a concave surface, the support member pivotally connected to the product receptacle and the channel member, and configured to rotate in a direction away from the support member upon actuation of the coin mechanism.

17. The coin mechanism of claim 16, wherein an upper edge of the product support member rotates beneath at least one product disposed above the selected product upon actuation of the coin mechanism, the upper edge providing support to the at least one product.

18. The coin mechanism of claim 17, wherein a lower edge of the product support member rotates away from the selected product during actuation of the coin mechanism, causing the selected product to be dispensed.

19. A coin mechanism for a vending machine requiring at least one coin before a selected product will be dispensed, comprising:
a support member having an inner surface and an outer surface;
a channel member rotatably connected to the support member, the channel member having a contoured channel formed thereon, the channel configured to define a coin slot when the channel member is in contact with the support member, the coin slot configured to receive and guide the at least one coin to a desired location, an actuator opening formed on the support and channel members at a location corresponding to the location of the at least one coin in the desired location, the channel member configured to normally be in contact with the support member and to displace relative to the support member when the coin mechanism is actuated, releasing at least one coin disposed in the contoured channel into a coin bank;
a coin guide attached to the channel member and protruding over the contoured channel, wherein the coin guide is configured to prevent the at least one coin disposed in the contoured channel from being released to a coin return receptacle when the channel member is displaced relative to the support member during actuation of the coin mechanism;
a coin return actuator connected to the support member, the return actuator comprising at least one protrusion protruding through the support member, the protrusion configured to hold the at least one coin at least in part against a wall of the contoured channel of the channel member when the channel member is in contact with the support member, the at least one protrusion further configured to travel in a second actuator opening formed on the support member to release the at least one coin into the coin return receptacle upon actuation of the coin return actuator;
an actuator comprising
a contact portion disposed frontward of the support member,
at least one support element movably disposed through the support and channel members, the at least one support element having a front portion disposed between the contact portion and the support member,
an actuation member configured to protrude through the actuator opening in the support member and engage the at least one coin disposed in the desired location against the channel member upon actuation of the coin mechanism, the actuation member further configured to protrude through the actuator opening formed on the channel member when the actuator is depressed by the user without the at least one coin disposed in the desired location, preventing the selected product from being dispensed,
a spring disposed between the channel member and a product receptacle, the spring configured to displace a flag member to engage at least one product disposed above the selected product through an opening in the product receptacle during actuation of the coin mechanism, and
a second spring disposed at the front portion of the at least one support element, the second spring configured to generate a return force on the contact portion when the actuator is actuated by the user; and
a product support member removably attached to the channel member, the product support member comprising an edge configured to releasably support the selected product disposed in the product receptacle, the product support member further defining an opening, the support member displaced upon actuation of the coin mechanism so that the edge disengages the selected product, allowing the selected product to be dispensed through the opening, the support member further configured to releasably support at least one product in the product receptacle disposed above the selected product upon dispensation of the selected product.

20. A coin mechanism for a vending machine requiring at least one coin before a selected product will be dispensed, comprising:
a support member having an inner surface and an outer surface;
a channel member rotatably connected to the support member, the channel member having a contoured channel formed thereon, the channel configured to define a coin slot when the channel member is in contact with the support member, the channel configured to receive and guide the at least one coin to a desired location, an actuator opening formed on the support and channel members at a location corresponding to the location of the at least one coin in the desired location, the channel member configured to normally be in contact with the support member and to displace relative to the support member when the coin mechanism is actuated, releasing at least one coin disposed in the contoured channel into a coin bank;
a coin guide attached to the channel member and protruding over the contoured channel, wherein the coin guide is configured to prevent the at least one coin disposed in the contoured channel from being released to a coin return receptacle when the channel member is displaced relative to the support member during actuation of the coin mechanism;
a coin return actuator connected to the support member, the return actuator comprising at least one protrusion protruding through the support member, the protrusion configured to hold the at least one coin at least in part against a wall of the contoured channel of the channel member when the channel member is in contact with the support member, the at least one protrusion further configured to travel in a second actuator opening formed on the support member to release the at least one coin into the coin return receptacle upon actuation of the return actuator;
an actuator comprising:
a contact portion disposed frontward of the support member,
at least one support element slidably disposed through the support and channel members, the at least one support element having a front portion disposed between the contact portion,
an actuation member configured to protrude through the actuator opening in the support member and engage the at least one coin disposed in the desired location against the channel member upon actuation of the coin mechanism, the actuation member further configured to protrude through the actuator opening formed on the channel member when the actuator is actuated by the user without the at least one coin disposed in the desired location, preventing the selected product from being dispensed,
a spring disposed between the channel member and a product receptacle, the spring configured to displace a flag member to engage at least one product disposed above the selected product through an opening in a product receptacle during actuation of the coin mechanism,
a second spring disposed at the front portion of the at least one support element, the second spring configured to generate a return force on the contact portion when the actuator is actuated by the user; and
a product support member removably connected to the channel member, the product support member comprising an edge configured to releasably support the selected product disposed in the product receptacle, the product support member having a generally concave surface, the support member pivotally connected to the product receptacle and configured to rotate in a direction away from the support member upon actuation of the coin mechanism, wherein an upper edge of the support member rotates beneath at least one product disposed above the selected product upon actuation of the coin mechanism, the upper edge providing support to the at least one product , and wherein a lower edge of the support member rotates away from the selected product during actuation of the coin mechanism, causing the selected product to be dispensed.

21. A coin mechanism for a vending machine comprising:
a contoured channel configured to receive and direct at least one coin to a desired location in the channel, the at least one coin disposed against a channel surface; and
an actuator configured to transmit a force onto one of the at least one coin to pivotably displace the channel about an axis to dispense a selected product from the vending machine.

22. A coin mechanism comprising:
a channel configured to receive and direct at least one coin to a desired location in the channel, the channel having a surface; and
an actuator configured to engage one of the at least one coin against the channel surface to movably displace the channel.

23. A method for dispensing a selected product from a vending machine requiring at least one coin before the selected product will be dispensed, comprising:
receiving the at least one coin in a contoured channel formed on at least one of a support and second movably connected members, the channel guiding the at least one coin to a desired location; and
actuating an actuator to transmit a force through an actuator opening formed on the support and channel members onto the at least one coin aligned with the actuator opening to displace the channel member relative to the support member to dispense the selected product.

24. A method for dispensing a selected product from a vending machine requiring at least one coin before the selected product will be dispensed, comprising:
receiving the at least one coin in a contoured channel formed on a channel member movably connected to a support member, the channel guiding the at least one coin to a desired location, the at least one coin resting at least in part between a wall of the contoured channel and a member on a coin return actuator, the member protruding through an actuator opening in the support member;
actuating an actuator having an actuation member to engage the at least one coin with an edge thereof against the channel member, the actuation member traveling through an actuator opening in the support member; and
displacing the channel member relative to the support member, causing a product support member connected to the channel member to disengage the selected product, causing the selected product to be dispensed.

25. The method of claim 24, wherein the actuation member has a stepped portion that causes the edge of the actuation member to shift when the stepped portion travels through the actuator opening, causing the edge of the actuation member to release the at least one coin.

26. The method of claim 24, wherein actuating the actuator causes a spring disposed between the channel member and the product receptacle to displace a flag member to engage at least one product disposed above the selected product through an opening in the product receptacle.

27. The method of claim 24 further comprising the step of releasing the actuator, causing a return force generated by at least one spring disposed between the actuator and the support member to displace the channel member into contact with the support member via a third member.

28. A method for dispensing a selected product from a vending machine requiring at least one coin before the selected product will be dispensed, comprising:
receiving the at least one coin in a contoured channel formed on a channel member movably connected to a rear side of a support member, the at least one coin resting proximate an actuation member connected to an actuator;
actuating said actuator to engage said coin disposed in the contoured channel against the channel member with the actuation member; and
displacing the channel member relative to the support member, causing a product support member connected to the channel member to remove support from the selected product to dispense the selected product.
